(19) United States
(12) Patent Application Publication
(10) Pub. No.: US 2026/0038886 A1
(43) Pub. Date: Feb. 5, 2026

(54) SULFONE-BASED ELECTROLYTE AND SECONDARY BATTERY COMPRISING SAME

(71) Applicant: Daegu Gyeongbuk Institute of Science and Technology, Daegu (KR)

(72) Inventors: Ho Chun LEE, Daegu (KR); Cheol Hee HAN, Daegu (KR)

(73) Assignee: Daegu Gyeongbuk Institute of Science and Technology, Daegu (KR)

(21) Appl. No.: 18/997,343

(22) PCT Filed: Apr. 25, 2023
(86) PCT No.: PCT/KR2023/005619

§ 371 Date: Jan. 21, 2025

(30) Foreign Application Priority Data
Jul. 22, 2022 (KR) 10-2022-0090700

(51) Int. Cl. H01M 10/42; H01M 10/052; H01M 10/0569

(52) U.S. Cl. CPC H01M 10/4235; H01M 10/052; H01M 10/0569; H01M 2300/0042

(57) ABSTRACT

The present invention relates to a sulfone compound-based electrolyte and a secondary battery including the sulfone compound-based electrolyte. The secondary battery according to the present invention can suppress gas generation in high temperature or thermal runaway environments or generate non-flammable gas to reduce the risk of ignition or explosion.

### TECHNICAL FIELD

The present invention relates to a sulfone compound-based electrolyte and a secondary battery including the sulfone compound-based electrolyte. A secondary battery according to the present invention can suppress gas generation in high temperature or thermal runaway environments or generate non-flammable gas to reduce the risk of ignition or explosion.

### BACKGROUND ART

Lithium secondary batteries using carbonate-based liquid electrolytes have a high risk of ignition and explosion. This is because carbonate-based liquid electrolytes are highly flammable, and carbonate-based electrolytes generate highly flammable gases such as hydrogen, carbon monoxide (CO), and hydrocarbons through electrochemical oxidation or reduction reactions inside a battery.

To compensate for the weaknesses of these carbonate electrolytes, phosphate compounds and ionic liquid-based electrolytes have been proposed. These electrolytes have flame-retardant properties and do not ignite easily even when exposed to flame. However, these electrolytes have poor electrolyte properties, which are detrimental to the life characteristics of lithium secondary batteries and ineffective in improving battery safety.

The reason why the application of flame-retardant electrolytes is not effective in improving stability is presumed to be because the gas generated through the oxidation/reduction reaction of the electrolyte still has high flammability.

Meanwhile, sulfone compound-based electrolytes exhibit excellent electrolyte solvent properties such as their own low flammability, high oxidation stability, and good dielectric constant. However, sulfone electrolytes have not been commercialized due to their low compatibility with graphite anodes which are typical anode materials for lithium secondary batteries. This is because sulfone compounds do not form an appropriate protective film (solid electrolyte interphase, SEI) on the surface of a graphite anode, which inhibits the reversible movement of lithium ions and may also cause exfoliation of the graphite anode. To compensate for these shortcomings, studies have been conducted to add other carbonate solvents and additives to a sulfone solvent, but the introduction of highly flammable carbonate solvents results in a decrease in battery safety.

Recently, it has been reported that sulfone electrolytes using high-concentration salts show significantly improved graphite anode suitability. However, there is a disadvantage in that the ionic conductivity of the electrolyte decreases and the wettability to an electrode and a separator decreases as a result of the viscosity increase due to the use of high-concentration salt. To improve the high viscosity and the wettability characteristics of an electrode and a separator, the present inventors conducted a study on the introduction of a fluorinated solvent (hydrofluoroether, HFE) as a diluent into a high-concentration electrolyte, and solved the problem of limiting the selection of solvents by using a fluorinated diluent that does not have miscibility with any solvents.

### DISCLOSURE

### Technical Problem

Therefore, the present invention has been made in view of the above problems, and it is one object of the present invention to significantly reduce the generation of decomposition gases by electrochemical oxidation/reduction reactions in a secondary battery containing a sulfone-based electrolyte.

It is another object of the present invention to maximize ion conductivity and wettability for a separator at the same time by introducing two types of sulfone solvents as electrolytes.

It is yet another object of the present invention to use a sulfone solvent having a specific functional group to maximize the solubility of a sulfone solvent and a hydrofluoroether solvent.

### Technical Solution

In accordance with an aspect of the present invention, the above and other objects can be accomplished by the provision of a sulfone-based electrolyte, including: a metal salt; dimethyl sulfone (DMS); a sulfone solvent represented by Formula 1 below; and a hydrofluoroether (HFE) solvent,

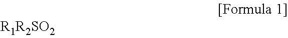

where R₁ and R₂ are each independently an alkyl group, and at least one of R₁ and R₂ has two or more carbon atoms.

According to an embodiment, the sulfone solvent may impart miscibility to the dimethyl sulfone and the hydrofluoroether solvent.

According to an embodiment, the sulfone-based electrolyte including the hydrofluoroether solvent may provide wettability to a separator for a secondary battery.

According to an embodiment, the hydrofluoroether solvent may reduce a viscosity of the sulfone-based electrolyte to 20 mPa·s to 70 mPa·s.

According to an embodiment, a molar ratio of a sulfone-based solvent including the dimethyl sulfone and the sulfone solvent to the metal salt may be 2:1 to 5:1.

According to an embodiment, a molar ratio of the dimethyl sulfone to the sulfone solvent may be 1:3 to 3:1.

According to an embodiment, a molar ratio of a sulfone-based solvent including the dimethyl sulfone and the sulfone solvent to the hydrofluoroether solvent may be 1:3 to 3:1.

According to an embodiment, the metal salt may be at least one selected from the group consisting of lithium bis(fluorosulfonyl)imide (LiFSI), sodium bis(fluorosulfonyl)imide (NaFSI), potassium bis(fluorosulfonyl)imide (KFSI), lithium bis(trifluoromethanesulfonyl)imide (LiTFSI), lithium tetrafluoroborate (LiBF₄) and lithium difluoro(oxalate)borate (LiDFOB).

According to an embodiment, the sulfone solvent may be at least one selected from the group consisting of ethyl methyl sulfone (EMS), sulfolane (SL), methyl iso-propyl sulfone (MiPS), 1,1,2,2-tetra-fluoro-3-(methylsulfonyl)propane (TFPMS), ethyl isopropyl sulfone (EiPS), 3-methylsulfolane (MSL), methoxyethylmethyl sulfone (MEMS), ethylmethoxyehtyl sulfone (EMES), ethylmethoxyethoxyethyl sulfone (EMEES), trimethylene sulfone (TriMS), 1-methyltrimethylene sulfone (MTS), and 3,3,3-trifluoropropylmethylene sulfone (FPSM).

According to an embodiment, the hydrofluoroether solvent may be at least one selected from the group consisting of 1,1,2,2-tetrafluoroethyl-2,2,3,3-tetrafluoropropyl ether (TTE), bis(2,2,2-trifluoroethyl) ether (BTFE), di-(1,1,3-trihydrotetrafluoropropoxy)methane (DTM), 1,1,2,2-tetrafluoroethyl-2,2,3,3-tetrafluoropropyl ether, 1,1,2,2-tetrafluoroethyl methyl ether, 1,1,2,2-tetrafluoroethl methyl ether, 1,1,1,2,3,3,6,6,7,7,-decafluoro-4-oxaheptane, 1,1,2,2,-tetrafluoroethyl methyl ether, ethyl-1,1,2,2-tetrafluoroethyl methyl ether and ethyl-4-(1,1,2,2,-tetrafluoroethoxy)benzoate.

In accordance with another aspect of the present invention, provided is a secondary battery, including: a positive electrode; a negative electrode; a separator; and the sulfone-based electrolyte according to the present invention.

According to an embodiment, the secondary battery may generate a non-flammable gas when stored at a high temperature.

According to an embodiment, the secondary battery may have an ion conductivity of 0.1 mS/cm to 10 mS/cm.

### Advantageous Effects

According to an embodiment of the present invention, in a secondary battery including a sulfone-based electrolyte, the generation of decomposition gases is significantly reduced by an electrochemical oxidation/reduction reaction, and most of the generated decomposition gases can be gases with low flammability.

According to an embodiment of the present invention, based on two kinds of sulfone compounds, the ion conductivity in a secondary battery and the wettability for a separator can be improved simultaneously.

According to an embodiment of the present invention, a sulfone solvent and a hydrofluoroether solvent can have miscibility.

### DESCRIPTION OF DRAWINGS

FIG. 1a illustrates the images of mixtures of respective types of sulfone compounds and a hydrofluoroether solvent.

FIGS. 1b to 1g illustrate the images of mixtures of LiFSI, different types of sulfone compounds, and a hydrofluoroether solvent.

FIGS. 2a and 2b are graphs illustrating the viscosity of mixed solutions dependent upon the temperature.

FIG. 3a illustrates the temperature-dependent ion conductivity of electrolytes containing different types of sulfone solvents.

FIG. 3b illustrates the ion conductivity of a sulfone-based electrolyte dependent upon the temperature.

The left image of FIG. 4 illustrates a polyethylene separator to which Comparative Example 7 is applied, and the right image thereof illustrates a polyethylene separator to which Example 1-1 is applied.

FIG. 5a illustrates the results of lifespan evaluation performed at 25° C. using Comparative Example 1-2 and Example 1-2.

FIG. 5b illustrates the results of lifespan evaluation performed at 60° C. using Comparative Example 1-2 and Example 1-2.

FIGS. 6a and 6b illustrate the acceleration rate calorimetry analysis results of 1 Ah-class NCM811/graphite batteries using Comparative Example 1-2 and Example 1-2.

FIGS. 7a and 7b illustrate the high-temperature swelling characteristics of 1 Ah-class NCM811/graphite batteries using Comparative Example 1-2 and Example 1-2.

FIGS. 8a and 8b illustrate the gas composition inside a battery using each of Comparative Example 1-2 and Example 1-2.

FIG. 8c illustrates graphs comparing the gas type-specific equivalents of Comparative Example 1-2 and Example 1-2.

### BEST MODE

The present invention will now be described more fully with reference to the accompanying drawings and contents disclosed in the drawings. However, the present invention should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the invention and the appended claims, the singular forms “a”, “an” and “the” are intended to include the plural forms as well, unless context clearly indicates otherwise.

In addition, when an element such as a layer, a film, a region, and a constituent is referred to as being “on” another element, the element can be directly on another element or an intervening element can be present.

A sulfone-based electrolyte according to the present invention includes a metal salt, dimethyl sulfone (DMS), a sulfone solvent represented by Formula 1 below and a hydrofluoroether (HFE) solvent:

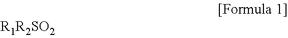

In Formula 1, R₁ and R₂ are each independently an alkyl group, and at least one of R₁ and R₂ have two or more carbon atoms.

The sulfone-based electrolyte according to the present invention significantly reduces the generation of decomposition gases generated by an electrochemical oxidation/reduction reaction at an electrode interface due to the unique characteristics of a sulfone compound, and generates decomposition gases with low flammability. In addition, it has low calorific power and thus has thermal stability compared to existing carbonate-based electrolytes.

A sulfone-based electrolyte introduces two types of sulfone compounds, i.e., a dimethyl sulfone and a non-dimethyl sulfone, a sulfone solvent, simultaneously to improve ion conductivity and wettability for a separator of a secondary battery, thereby increasing the output characteristics of the battery. Here, the ions of ion conductivity refer to cations and anions formed by the dissociation of a metal salt. For example, if the metal salt is LiFSI, the ions of ion conductivity mean Li⁺ and FSI⁻.

Dimethyl sulfone (DMS) exhibits excellent electrochemical stability and has a high dielectric constant. In addition, dimethyl sulfone contributes to high ion conductivity, which may be due to the high polarity and low steric hindrance effect due to the short alkyl chain length of dimethyl sulfone. However, due to the high polarity of such a short methyl chain, it shows very low solubility in a nonpolar hydrofluoroether solvent.

According to an embodiment, a sulfone solvent represented by Formula 1 may make dimethyl sulfone and a hydrofluoroether solvent miscible.

The term “miscibility” is also used as mixability, and refers to the property of two or more liquids to dissolve and combine when mixed.

The sulfone solvent is represented by Formula R₁R₂SO₂, where R₁ and R₂ are each independently an alkyl group, and at least one of R₁ and R₂ has two or more carbon atoms. That is, one of R₁ and R₂ or both R₁ and R₂ are an alkyl group having two or more carbon atoms.

Unlike dimethyl sulfone, a sulfone solvent is miscible with a hydrofluoroether solvent. A sulfone solvent has sufficient hydrophobic properties because it has an alkyl group with a longer chain length than dimethyl sulfone. Likewise, a hydrofluoroether solvent is nonpolar, so it can have high solubility or miscibility with a sulfone solvent.

A hydrofluoroether (HFE) solvent has a disadvantage in that a solvent that can be used together with HFE is limited due to miscibility issues. However, the present invention addresses the miscibility problem by using a long functional group having two or more carbon atoms.

A sulfone compound acts as a medium for moving ions involved in the electrochemical reaction of a battery.

In a sulfone-based electrolyte, a hydrofluoroether solvent can lower the viscosity of the electrolyte and improve the wettability of a separator of a secondary battery.

In addition, a hydrofluoroether solvent contains a large amount of fluorine (F) and thus can form a LiF layer with high thermal stability on an electrode surface.

According to an embodiment, hydrofluoroether is a low-viscosity material that can reduce the viscosity of a sulfone-based electrolyte including the hydrofluoroether from 190.5 mPa·s to 20 mPa·s to 70 mPa·s at room temperature.

According to an embodiment, hydrofluoroether can cause a sulfone-based electrolyte to have wettability for a separator of a secondary battery.

Wettability is the ability of a liquid to maintain contact with a solid surface, which occurs due to intermolecular interactions that occur when the liquid and the solid meet. A sulfone-based electrolyte whose viscosity is reduced due to the inclusion of hydrofluoroether has increased penetration into a solid substrate, thereby having improved wettability for a separator.

According to an embodiment, a solution not including hydrofluoroether may have a contact angle of 82.3° to 78.4° with respect to a separator. In contrast, the solution including hydrofluoroether may have a contact angle of 20.1° to 23.4° with respect to a separator.

The wettability of the electrolyte can be improved by adding the hydrofluoroether solvent. As the wettability is improved, the electrolyte may better penetrate into the pores of the separator, and the ion conductivity of the separator may be improved. The improved ion conductivity may lead to a decrease in battery overpotential, thereby improving battery output performance.

In this specification, the term “sulfone-based solvent” is used as a term including dimethyl sulfone and a sulfone solvent.

According to an embodiment, a molar ratio of the sulfone-based solvent including dimethyl sulfone and the sulfone solvent to the metal salt may be 2:1 to 5:1. Preferably, the molar ratio may be 3:1.

When the content of the metal salt is below than the range, the number of ions generated by dissociation of the metal salt is insufficient, which may cause a problem of decreased ion conductivity, and when the content of the metal salt exceeds the range, the viscosity of the electrolyte increases, which may cause a decrease in ion conductivity and a decrease in viscosity for a separator.

According to an embodiment, a molar ratio of dimethyl sulfone to the sulfone solvent may be 1:3 to 3:1. Preferably, the molar ratio may be 1:1.

When the content of dimethyl sulfone is below the range, it is difficult to secure ion conductivity, and when the content of the sulfone solvent is below the range, there may be a problem that miscibility with hydrofluoroether decreases.

According to an embodiment, a molar ratio of the sulfone-based solvent including dimethyl sulfone and the sulfone solvent to the hydrofluoroether solvent may be 1:3 to 3:1. Preferably, the molar ratio may be 3:2.

When the content of the hydrofluoroether solvent is below the range, the viscosity of the electrolyte may not be sufficiently reduced, and when the content of the sulfone-based solvent including dimethyl sulfone is below the range, there is a problem that ion conductivity decreases.

The most preferred molar ratio of the metal salt: the dimethyl sulfone: the sulfone solvent: the hydrofluoroether solvent is 1:1.5:1.5:2.

According to an embodiment, the metal salt may be at least one selected from the group consisting of lithium bis(fluorosulfonyl)imide (LiFSI), sodium bis(fluorosulfonyl)imide (NaFSI), potassium bis(fluorosulfonyl)imide (KFSI), lithium bis(trifluoromethanesulfonyl)imide (LiTFSI), lithium tetrafluoroborate (LiBF₄) and lithium difluoro(oxalate)borate (LiDFOB).

As the sulfone-based electrolyte, various types of metal salts may be used, but MFSI or MTFSI (M is an alkali metal such as Li, Na, or K) is preferable in terms of ion conductivity. FSI anions or TFSI anions may exhibit high ion conductivity due to high molecular similarity with a sulfone compound in terms of —SO₂ functional group.

The metal salt is dissolved in the sulfone-based solvent and acts as a source of alkali metal ions in the battery.

According to an embodiment, the sulfone solvent may be at least one selected from the group consisting of ethyl methyl sulfone (EMS), sulfolane (SL), methyl iso-propyl sulfone (MiPS), 1,1,2,2-tetra-fluoro-3-(methylsulfonyl)propane (TFPMS), ethyl isopropyl sulfone (EiPS), 3-methylsulfolane (MSL), methoxyethylmethyl sulfone (MEMS), ethylmethoxyehtyl sulfone (EMES), ethylmethoxyethoxyethyl sulfone (EMEES), trimethylene sulfone (TriMS), 1-methyltrimethylene sulfone (MTS), and 3,3,3-trifluoropropylmethylene sulfone (FPSM).

In the sulfone solvent, at least one of the two alkyl functional groups bonded to sulfur (S) has two or more carbon atoms, and thus the sulfone solvent has a longer-chain functional group than dimethyl sulfone.

According to an embodiment, the hydrofluoroether solvent may be at least one selected from the group consisting of 1,1,2,2-tetrafluoroethyl-2,2,3,3-tetrafluoropropyl ether (TTE), bis(2,2,2-trifluoroethyl) ether (BTFE), di-(1,1,3-trihydrotetrafluoropropoxy)methane (DTM), 1,1,2,2-tetrafluoroethyl-2,2,3,3-tetrafluoropropyl ether, 1,1,2,2-tetrafluoroethyl methyl ether, 1,1,2,2-tetrafluoroethl methyl ether, 1,1,1,2,3,3,6,6,7,7,-decafluoro-4-oxaheptane, 1,1,2,2,-tetrafluoroethyl methyl ether, ethyl-1,1,2,2-tetrafluoroethyl methyl ether and ethyl-4-(1,1,2,2,-tetrafluoroethoxy)benzoate.

The secondary battery according to the present invention includes a positive electrode, a negative electrode, a separator and a sulfone-based electrolyte.

The positive electrode includes a known positive electrode active material in the relevant technical field. The cathode active material may be a composite oxide of a metal selected from cobalt, manganese, nickel, vanadium, and combinations thereof, and lithium, but is not limited thereto.

A negative electrode includes a known negative electrode active material in the relevant technical field. The negative electrode active material may be, but is not limited to, a carbon-based negative electrode active material, a silicon-based negative electrode active material or a mixture thereof. Preferably, the carbon-based negative electrode active material may be graphite.

The separator may be one selected from among polyethylene (PE), polypropylene (PP), polyvinylidene fluoride (PVDF), polytetrafluoroethylene (PTFE) and polyethylene terephthalate (PET).

According to an embodiment, the secondary battery may generate a non-flammable gas at high temperatures.

A secondary battery including a sulfone-based electrolyte has excellent stability even at high temperatures, compared to a carbonate-based electrolyte, due to the unique properties of sulfone, and thus the amount of gas generated is reduced, and non-flammable gases such as CO₂ and SO₂ may be mainly generated. A sulfone-based solvent can easily generate SO₂ gas because it contains a —SO₂— functional group.

According to an embodiment, the secondary battery may have an ion conductivity of 0.1 mS/cm to 10 mS/cm. The secondary battery according to the present invention uses dimethyl sulfone having the highest ion conductivity among various sulfone-based solvents, uses a hydrofluoroether solvent to improve wettability for a separator, and uses a sulfone solvent whose at least one alkyl group has two or more carbon atoms to use the above-described sulfone-based electrolyte in which dimethyl sulfone and the hydrofluoroether solvent are well mixed, thereby exhibiting excellent ion conductivity as described above. The improvement of ionic conductivity means excellent electrical conductivity, which leads to improved battery output performance.

Hereinafter, the present invention will be described in more detail through examples. These examples are intended to explain the present invention in more detail, and the scope of the present invention is not limited by these examples.

### Comparative Example 1-1

Ethylene carbonate (EC) and ethyl methyl carbonate (MC) were mixed as solvents such that the concentration of LiPF₆ as a metal salt was 1 M, and the two solvents were mixed in a volume ratio of 1:2 to prepare an electrolyte.

### Comparative Example 1-2

The electrolyte of Comparative Example 1-1 was injected into a 1 Ah-class NCM811/graphite aluminum pouch battery manufactured using an NCM811 positive electrode, a graphite negative electrode and a polyethylene (PE) separator.

### Comparative Example 2

An electrolyte was prepared so that a molar ratio of LiFSI as a metal salt to dimethyl sulfone (DMS) was 1:3.

### Comparative Example 3

An electrolyte was prepared so that a molar ratio of LiFSI as a metal salt to ethyl methyl sulfone (EMS) was 1:3.

### Comparative Example 4

An electrolyte was prepared so that a molar ratio of LiFSI as a metal salt to sulfolane (SL) was 1:3.

### Comparative Example 5

An electrolyte was prepared so that a molar ratio of LiFSI as a metal salt to dimethyl sulfone (DMS) to sulfolane (SL) as a sulfone solvent was 1:1.5:1.5.

### Comparative Example 6

An electrolyte was prepared so that a molar ratio of LiFSI as a metal salt to dimethyl sulfone (DMS) to ethyl methyl sulfone (EMS) as a sulfone solvent was 1:1.5:1.5.

### Comparative Example 7

An electrolyte was prepared so that a molar ratio of LiFSI as a metal salt to dimethyl sulfone (DMS) to methyl iso-propyl sulfone (MiPS) as a sulfone solvent was 1:1.5:1.5.

### Example 1-1

An electrolyte was prepared so that a molar ratio of LiFSI as a metal salt to dimethyl sulfone (DMS) to sulfolane (SL) as a sulfone solvent to 1,1,2,2-tetrafluoroethyl-2,2,3,3-tetrafluoropropyl ether (TTE) as a hydrofluoroether solvent was 1:1.5:1.5:2.

### Example 1-2

The electrolyte of Example 1-1 was injected into a 1 Ah-class NCM811/graphite aluminum pouch battery manufactured using an NCM811 positive electrode, a graphite negative electrode and a polyethylene (PE) separator.

The comparative examples and the examples are summarized in Table 1 below.

TABLE 1

| | Composition ratio |
|---|---|
| Comparative Example 1-1 | 1M LiPF₆ 1EC + 2EMC (volume ratio) electrolyte |
| Comparative Example 1-2 | 1M LiPF₆ 1EC + 2EMC (volume ratio) battery |
| Comparative Example 2 | 1LiFSI + 3DMS (molar ratio) electrolyte |
| Comparative Example 3 | 1LiFSI + 3EMS (molar ratio) electrolyte |
| Comparative Example 4 | 1LiFSI + 3SL (molar ratio) electrolyte |
| Comparative Example 5 | 1LiFSI + 1.5DMS + 1.5SL (molar ratio) electrolyte |
| Comparative Example 6 | 1LiFSI + 1.5DMS + 1.5EMS (molar ratio) electrolyte |
| Comparative Example 7 | 1LiFSI + 1.5DMS + 1.5MiPS (molar ratio) electrolyte |
| Example 1-1 | 1.5LiFSI + 1.5DMS + 1.5SL + 2TTE (molar ratio) electrolyte |
| Example 1-2 | 1.5LiFSI + 1.5DMS + 1.5SL + 2TTE (molar ratio) battery |

### [Experimental Example 1] Ion Conductivity Dependent Upon Type of Sulfone

To compare the ionic conductivity dependent upon the type of sulfone compound, a metal salt and various types of sulfone compounds were mixed at a molar ratio of 1:3, and the ionic conductivity was measured at 25° C. and 30° C. Results are shown in Table 2 below.

TABLE 2

| | 25° C. ion | 30° C. ion |
|---|---|---|
| | conductivity (mS/cm) | conductivity (mS/cm) |
| Comparative Example 2 | 2.00 | 2.48 |
| (1LiFSI + 3DMS) | | |
| Comparative Example 3 | 1.38 | 1.71 |
| (1LiFSI + 3EMS) | | |
| Comparative Example 4 | 1.81 | 2.16 |
| (1LiFSI + 3SL) | | |

Referring to Table 2, it can be confirmed that, among several sulfone compounds, dimethyl sulfone (DMS) has the highest ion conductivity. The highest ion conductivity of dimethyl sulfone can be seen as a result of the high polarity and low steric hindrance of the methyl group. Dimethyl sulfone is most suitable for use as an electrolyte solvent for a secondary battery due to its high ion conductivity, so in the present invention, dimethyl sulfone was used as a fixed component of the electrolyte.

### [Experimental Example 2-1] Miscibility of Sulfone and Hydrofluoroether Solvent

To compare the solubility of sulfone compounds in the hydrofluoroether solvent, each type of sulfone compound (DMS, SL, MiPS) was mixed with a hydrofluoroether solvent (TTE, DTM, BTFE) in a molar ratio of 1:1.

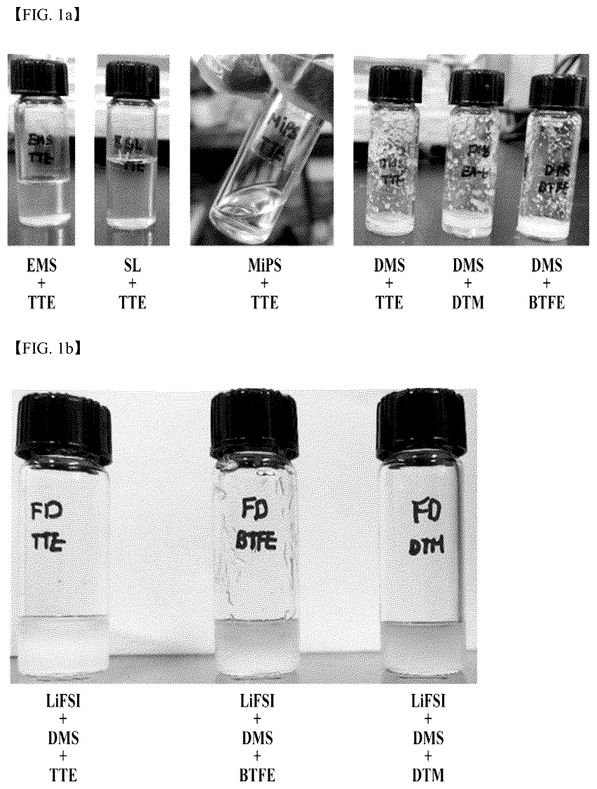

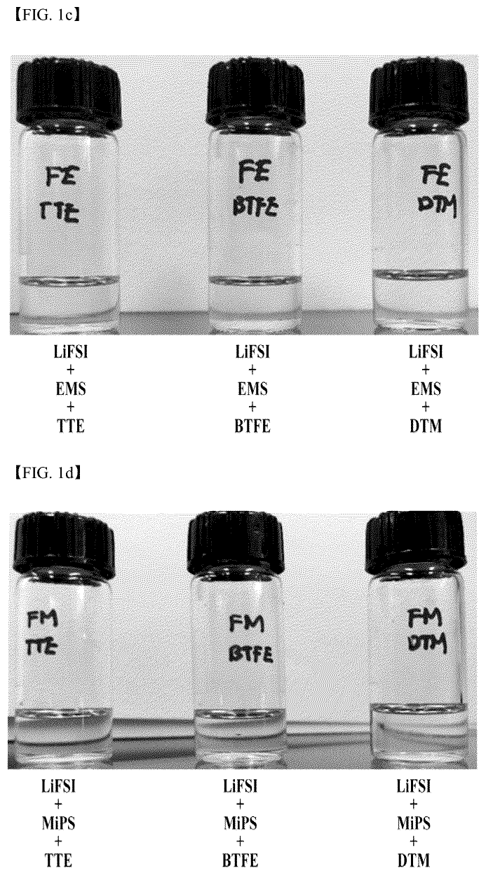

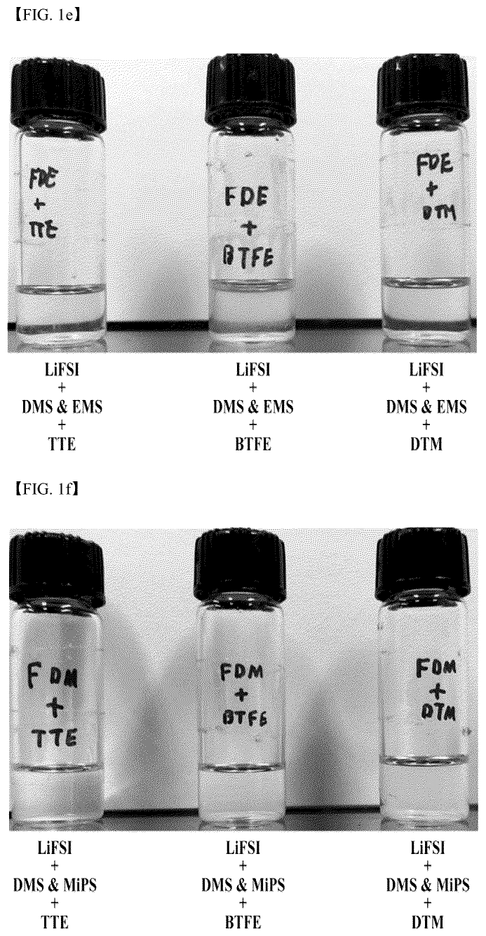

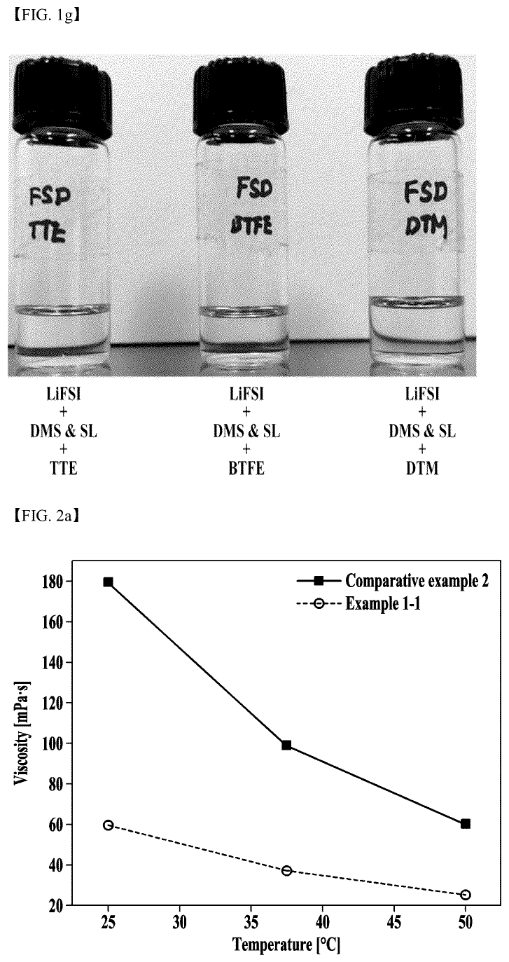

FIG. 1a illustrates the images of mixtures of respective types of sulfone compounds and a hydrofluoroether solvent.

Referring to FIG. 1a, it can be confirmed that EMS, SL, and MiPS are dissolved in TTE, and EMS, SL, and MiPS are miscible with a hydrofluoroether solvent. On the other hand, DMS is insoluble in TTE, DTM, and BTFE, so it can be seen that DMS is not miscible with a hydrofluoroether solvent.

Utilizing these results, experiments were conducted to determine whether dimethyl sulfone and a hydrofluoroether solvent would be mixed when a sulfone solvent (EMS, SL, MiPS) was added. LiFSI was used as a metal salt, and when metal salt, dimethyl sulfone (or a sulfone solvent), and a hydrofluoroether solvent were used, they were mixed in a molar ratio of 1:3:2, and when metal salt, dimethyl sulfone, a sulfone solvent, and a hydrofluoroether solvent were used, they were mixed in a molar ratio of 1:1.5:1.5:2.

FIGS. 1b to 1g illustrate the images of mixtures of LiFSI, different types of sulfone compounds, and a hydrofluoroether solvent.

Referring to FIG. 1b, dimethyl sulfone and the hydrofluoroether solvent were not miscible with each other. That is, there was no miscibility. On the other hand, referring to FIGS. 1c and 1d, when a sulfone solvent (EMS or MiPS) other than dimethyl sulfone was used, there was miscibility with the hydrofluoroether solvent.

Referring to FIGS. 1e to 1g, it can be confirmed that, when dimethyl sulfone and a sulfone solvent (one of EMS, MiPS, and SL) are used, they are well mixed with a hydrofluoroether solvent.

Therefore, Experimental Example 2-1 suggests that, to impart miscibility to dimethyl sulfone and a hydrofluoroether solvent in an electrolyte containing a metal salt, a sulfone solvent having a functional group of two or more carbon atoms, such as EMS, MiPS, or SL, should be used.

### [Experimental Example 2-2] Viscosity of Electrolyte Due to Hydrofluoroether

The viscosity of the solutions mixed in Experimental Example 2-1 was measured and shown in Table 3 below.

FIGS. 2a and 2b are graphs illustrating the viscosity of mixed solutions dependent upon the temperature.

Referring to FIGS. 2a and 2b and Table 3, it can be confirmed that the viscosity of the solution is the lowest in Example 1-1 where hydrofluoroether is added. Hydrofluoroether is a low-viscosity material, and it was suggested that the overall viscosity of the sulfone-based electrolyte can be lowered and the wettability for the separator can be improved by adding hydrofluoroether to Comparative Example 5 which has improved miscibility compared to Comparative Example 2.

TABLE 3

| | Comparative | Comparative | Example |
|---|---|---|---|
| Temperature | Example 2 | Example 5 | 1-1 |

| | | | | | |
|---|---|---|---|---|---|
| 25° | C. | 79.6 mPa · s | 190.5 | mPas | 59.5 mPa · s |
| 37.5° | C. | 98.5 mPa · s | 106.9 | mPa · s | 37.1 mPa · s |
| 50° | C. | 60.3 mPa · s | 66.8 | mPa · s | 24.9 mPa · s |

### [Experimental Example 2-3] Contact Angle Due to Hydrofluoroether

The contact angle for a PE separator was measured using Comparative Example 5 and Example 1-1.

The solution excluding hydrofluoroether (Comparative Example 5) had a contact angle of 82.3° for the separator, and the solution containing hydrofluoroether (Example 1-1) had a contact angle of 20.1° for the separator. It can be confirmed that the solution containing hydrofluoroether has a reduced viscosity due to the decrease in the contact angle, thus having improved wettability for the separator substrate.

### [Experimental Example 3] Ion Conductivity Due to Sulfone Solvent

To compare the ionic conductivity dependent upon the types of sulfone solvents, a metal salt, dimethyl sulfone, and several types of sulfone solvents were mixed in a molar ratio of 1:1.5:1.5, and the ionic conductivity according to temperature change was measured.

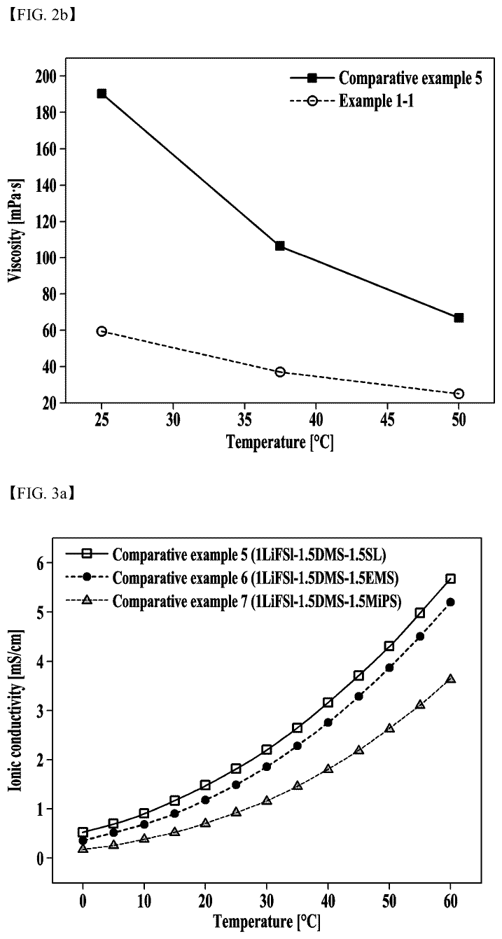

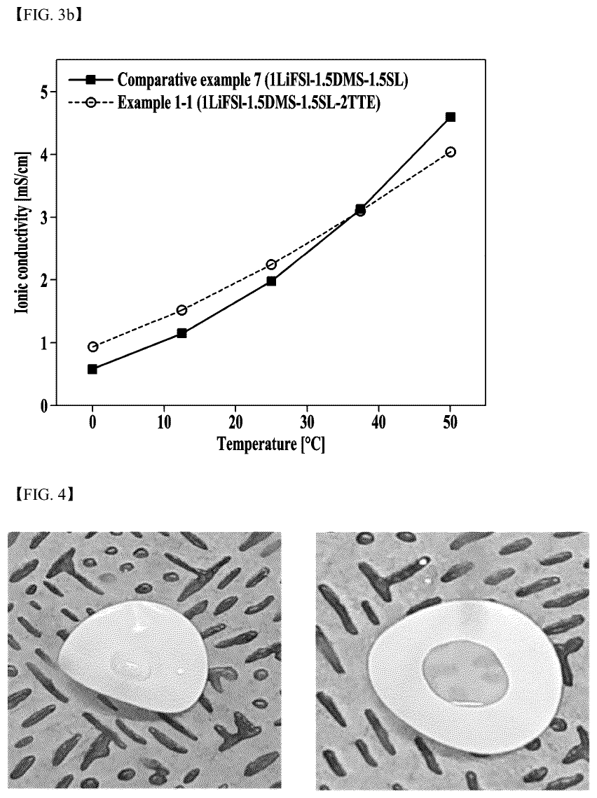

FIG. 3a illustrates the temperature-dependent ion conductivity of electrolytes containing different types of sulfone solvents. Referring to FIG. 3a, it can be confirmed that ion conductivity is superior in the order of SL, EMS, and MiPS.

Since SL has the highest dielectric constant and its molecular size is small, the ion conductivity of the solution containing SL is the highest.

### [Experimental Example 4] Ion Conductivity Due to Hydrofluoroether Solvent

To compare the ion conductivity according to the presence and type of a hydrofluoroether solvent, a metal salt, dimethyl sulfone, and hydrofluoroether were mixed in the molar ratios shown in Table 4 below, and the ion conductivity was measured at 0° C. and 25° C.

TABLE 4

| | Ion conductivity | Ion conductivity |
|---|---|---|
| | (mS/cm) at 0° C. | (mS/cm) at 25° C. |
| Comparative Example | 0.58 | 1.97 |
| 7(1LiFSI + 1.5DMS + 1.5SL) | | |
| Example 1- | 0.93 | 2.24 |
| 1(1.5LiFSI + 1.5DMS + | | |
| 1.5SL + 2TTE) | | |

FIG. 3b illustrates the ion conductivity of a sulfone-based electrolyte dependent upon the temperature.

In the case of Example 1-1, the viscosity was significantly reduced in all temperature ranges, and the wettability for the separator was also improved, showing that the ion conductivity was improved in most ranges.

### [Experimental Example 5] PE Separator Wettability Dependent Upon Presence or Absence of Hydrofluoroether Solvent

To confirm the wettability of a separator due to a hydrofluoroether solvent, Comparative Example 7 and Example 1-1 were used for polyethylene (PE).

The left image of FIG. 4 illustrates a polyethylene separator to which Comparative Example 7 is applied, and the right image thereof illustrates a polyethylene separator to which Example 1-1 is applied.

Referring to FIG. 4, Comparative Example 7 (1LiFSI+1.5DMS+1.5SL) has no PE wettability for the separator, while Example 1-1 (1LiFSI+1.5DMS+1.5SL+2TTE) has excellent wettability for the PE separator due to the addition of a hydrofluoroether solvent.

### [Experimental Example 6] Lifespan Characteristics of Battery

The lifespan evaluation of the batteries of Comparative Example 1-2 and Example 1-2 was performed at 2.7 V to 4.2 V under CC/CV charging and CC discharging conditions with 0.2 C current (=0.2 A).

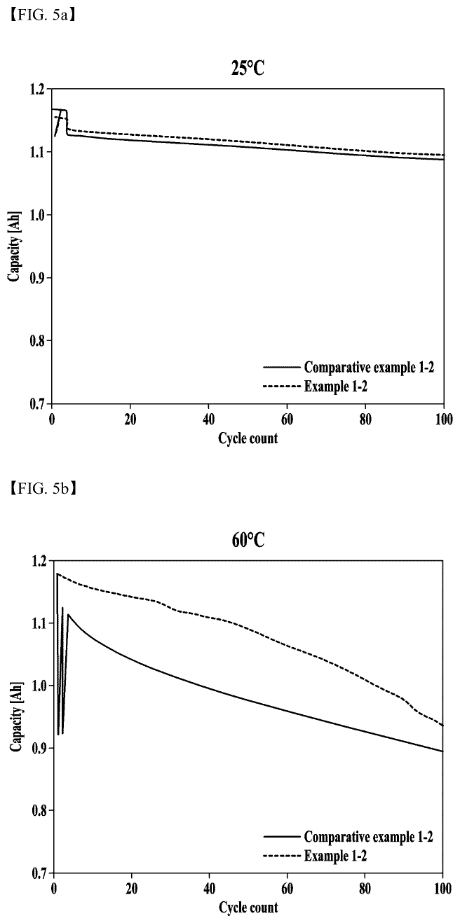

FIG. 5a illustrates the results of lifespan evaluation performed at 25° C. using Comparative Example 1-2 and Example 1-2.

FIG. 5b illustrates the results of lifespan evaluation performed at 60° C. using Comparative Example 1-2 and Example 1-2.

Referring to FIGS. 5a and 5b, Example 1-2 (electrolyte: 1LiFSI+1.5DMS+1.5SL+2TTE) shows lifespan characteristics equivalent to or greater than that of an existing battery of Comparative Example 1-2 applied with carbonate electrolyte (electrolyte: 1 M LiPF₆ 1EC+2EMC). The electrolyte applied with two kinds of sulfone compounds and a hydrofluoroether solvent according to the present invention has excellent initial capacity, especially in a high-temperature environment.

### [Experimental Example 7] Battery Stability Evaluation (ARC Evaluation)

To compare the safety of 1 Ah-class NCM811/graphite pouch batteries, accelerating rate calorimetry (ARC) experiments were performed. Each battery was subjected to ARC analysis when fully charged in the final cycle after 3 initial charge/discharge cycles. Results are shown in Table 5 below.

TABLE 5

| | T1 (° C.) | T2 (° C.) |
|---|---|---|
| Comparative Example 1-2 | 95 | 156.8 |
| Example 1-2 | 99 | 191.7 |

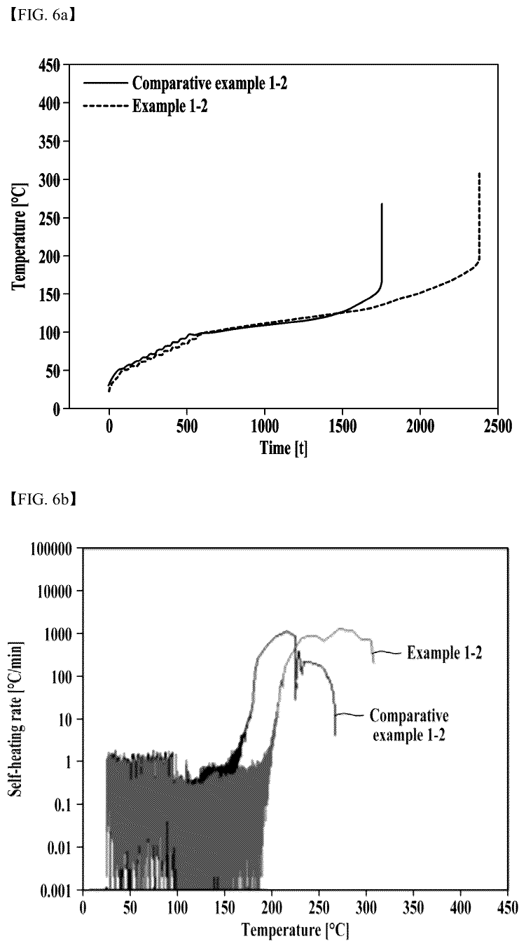

FIGS. 6a and 6b illustrate the acceleration rate calorimetry analysis results of 1 Ah-class NCM811/graphite batteries using Comparative Example 1-2 and Example 1-2.

Referring to FIG. 6a, Example 1-2 (electrolyte: 1LiFSI+1.5DMS+1.5SL+2TTE) showed higher exothermic onset temperature (T1) and thermal runaway onset temperature (T2) than Comparative Example 1-2 (electrolyte: 1 M LiPF₆ 1EC+2EMC). Referring to FIG. 6b, the self-heating rate (SHR) of Example 1-2 also shows that Comparative Example 1-2 shifts to the right.

Referring to FIG. 6b, when comparing the temperatures at which the self-heating rate reaches 1° C./min, Example 1-2 is about 191.7° C., while Comparative Example 1-2 is about 156.8° C., which shows that Example 1-2 has an increased self-heating rate at a higher temperature than Comparative Example 1-2. That is, in the ARC analysis results, the battery of Example 1-2 shows improved safety compared to the battery of Comparative Example 1-2.

### [Experimental Example 8-1] Battery Stability Evaluation (Gas Generation Comparison)

The high-temperature swelling characteristics of 1 Ah-class NCM811/graphite pouch batteries were compared. Each of the batteries was fully charged in the last cycle after 3 initial charge/discharge cycles, and a thickness change in the battery was observed by storing it in a 120° C. oven for 6 hours.

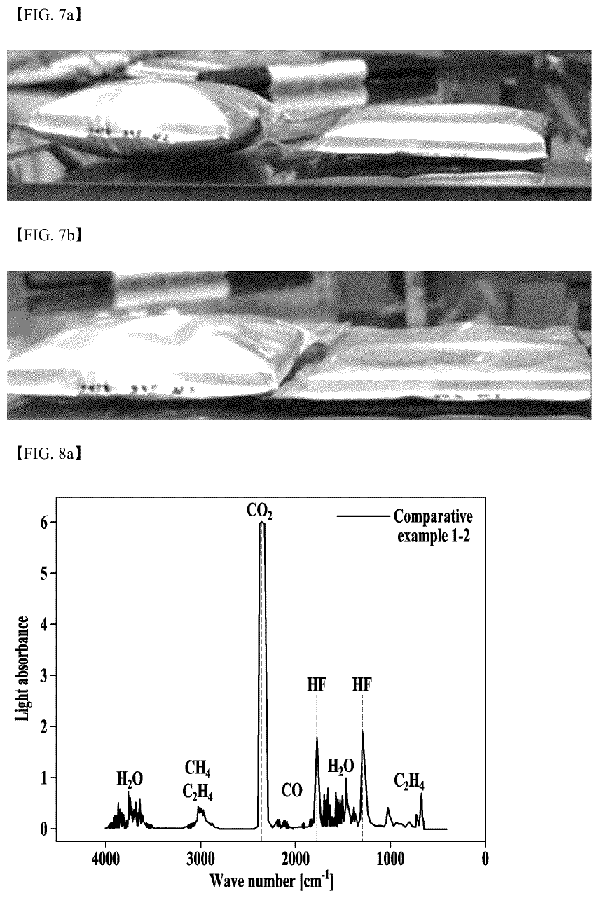

FIGS. 7a and 7b illustrate the high-temperature swelling characteristics of 1 Ah-class NCM811/graphite batteries using Comparative Example 1-2 and Example 1-2.

FIG. 7a illustrates results after 6 hours of storage at 120° C., and FIG. 7b illustrates results after 1 hour of storage at 25° C. It can be seen that Example 1-2 (electrolyte: LiFSI+DMS+SL+TTE) significantly suppresses the increase in battery thickness compared to Comparative Example 1-2 (electrolyte: 1 M LiPF₆ EC/EMC). The electrolyte of Example 1-2 showed relatively excellent thermal stability, which suppressed gas generation inside the battery.

### [Experimental Example 8-2] Battery Stability Evaluation (Gas Composition Comparison)

To analyze the compositions of gases generated from 1 Ah-class NCM811/graphite batteries during high-temperature storage, Comparative Example 1-2 (electrolyte: 1 M LiPF₆ EC/EMC) and Example 1-2 (electrolyte: LiFSI+DMS+SL+TTE) were stored in a 120° C. oven for 6 hours, then taken out and cooled at 25° C. for 1 hour. Gases were extracted from the batteries and Fourier-transform infrared spectroscopy (FT-IR) was performed.

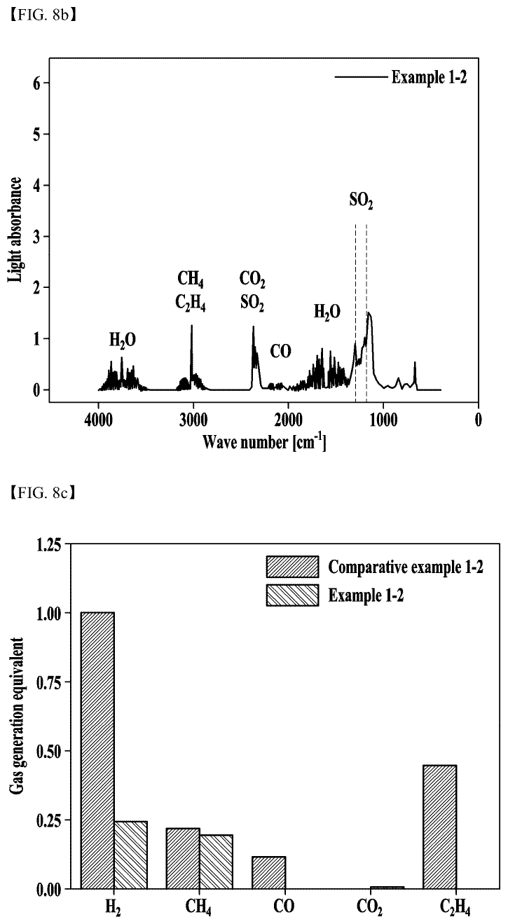

FIGS. 8a and 8b illustrate the gas composition inside a battery using each of Comparative Example 1-2 and Example 1-2.

FIG. 8c illustrates graphs comparing the gas type-specific equivalents of Comparative Example 1-2 and Example 1-2.

FIGS. 8a and 8b illustrate the results of a relative comparison of gas components for gas samples of the same volume. Therefore, as can be seen from FIG. 7a, it should be considered that the gas emission amount of Example 1 is significantly less than that of Comparative Example 1-2. Referring to FIG. 8a, the gas generated in Comparative Example 1-2 contains a large amount of flammable gases (CH₄, C₂H₄, CO). On the other hand, referring to FIG. 8b, the gas components generated in Example 1-2 are mainly non-flammable gases such as CO₂ and SO₂.

FIG. 8c, and Table 6 below show the generation amount of remaining gases when the generation amount of hydrogen gas is set to 1 equivalent. It can be confirmed that the generation amount of flammable gases such as H₂, CH₄, CO, and C₂H₄ is significantly reduced in Example 1-2.

TABLE 6

| | Comparative | | Gas generation amount ratio |
|---|---|---|---|
| Gas | Example 1-2 | Example 1-2 | (Comparative Example 1-2/ |
| component | (equivalent) | (equivalent) | Example 1-2) |
| H₂ | 1 | 0.24 | 4.17 |
| CH₄ | 0.22 | 0.19 | 1.16 |
| CO | 0.11 | <0.01 | 205.26 |
| CO₂ | <0.01 | <0.01 | 0.52 |
| C₂H₄ | 0.44 | <0.01 | 318.22 |

From the results of Experimental Example 8, it can be seen that Example 1-2 not only significantly reduces the amount of gas generated at high temperatures, but also the composition of the generated gases is mainly composed of non-flammable gases. Together with the ARC analysis results of Experimental Example 7, this supports that the battery provided according to Example 1-2 has excellent thermal safety.

Although the present invention has been described through limited examples and drawings, the present invention is not intended to be limited to the examples. Those skilled in the art will appreciate that various modifications, additions and substitutions are possible, without departing from the scope and spirit of the invention. Therefore, the scope of the present invention should not be limited to the described examples, but should be defined not only by the claims described below but also by equivalents of these claims.

1. A sulfone-based electrolyte, comprising:
a metal salt;
dimethyl sulfone (DMS);
a sulfone solvent represented by Formula 1 below; and
a hydrofluoroether (HFE) solvent, 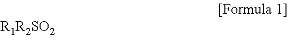
where R₁ and R₂ are each independently an alkyl group, and at least one of R₁ and R₂ has two or more carbon atoms.

2. The sulfone-based electrolyte according to claim 1, wherein the sulfone solvent imparts miscibility to the dimethyl sulfone and the hydrofluoroether solvent.

3. The sulfone-based electrolyte according to claim 1, wherein the sulfone-based electrolyte comprising the hydrofluoroether solvent provides wettability to a separator for a secondary battery.

4. The sulfone-based electrolyte according to claim 1, wherein the hydrofluoroether solvent reduces a viscosity of the sulfone-based electrolyte to 20 mPa·s to 70 mPa·s at room temperature.

5. The sulfone-based electrolyte according to claim 1, wherein a molar ratio of a sulfone-based solvent comprising the dimethyl sulfone and the sulfone solvent to the metal salt is 2:1 to 5:1.

6. The sulfone-based electrolyte according to claim 1, wherein a molar ratio of the dimethyl sulfone to the sulfone solvent is 1:3 to 3:1.

7. The sulfone-based electrolyte according to claim 1, wherein a molar ratio of a sulfone-based solvent comprising the dimethyl sulfone and the sulfone solvent to the hydrofluoroether solvent is 1:3 to 3:1.

8. The sulfone-based electrolyte according to claim 1, wherein the metal salt is at least one selected from the group consisting of lithium bis(fluorosulfonyl)imide (LiFSI), sodium bis(fluorosulfonyl)imide (NaFSI), potassium bis(fluorosulfonyl)imide (KFSI), lithium bis(trifluoromethanesulfonyl)imide (LiTFSI), lithium tetrafluoroborate (LiBF₄) and lithium difluoro(oxalate)borate (LiDFOB).

9. The sulfone-based electrolyte according to claim 1, wherein the sulfone solvent is at least one selected from the group consisting of ethyl methyl sulfone (EMS), sulfolane (SL), methyl iso-propyl sulfone (MiPS), 1,1,2,2-tetra-fluoro-3-(methylsulfonyl)propane (TFPMS), ethyl isopropyl sulfone (EiPS), 3-methylsulfolane (MSL), methoxyethylmethyl sulfone (MEMS), ethylmethoxyehtyl sulfone (EMES), ethylmethoxyethoxyethyl sulfone (EMEES), trimethylene sulfone (TriMS), 1-methyltrimethylene sulfone (MTS), and 3,3,3-trifluoropropylmethylene sulfone (FPSM).

10. The sulfone-based electrolyte according to claim 1, wherein the hydrofluoroether solvent is at least one selected from the group consisting of 1,1,2,2-tetrafluoroethyl-2,2,3,3-tetrafluoropropyl ether (TTE), bis(2,2,2-trifluoroethyl) ether (BTFE), di-(1,1,3-trihydrotetrafluoropropoxy)methane (DTM), 1,1,2,2-tetrafluoroethyl-2,2,3,3-tetrafluoropropyl ether, 1,1,2,2-tetrafluoroethyl methyl ether, 1,1,2,2-tetrafluoroethl methyl ether, 1,1,1,2,3,3,6,6,7,7,-decafluoro-4-oxaheptane, 1,1,2,2,-tetrafluoroethyl methyl ether, ethyl-1,1,2,2-tetrafluoroethyl methyl ether and ethyl-4-(1,1,2,2,-tetrafluoroethoxy)benzoate.

11. A secondary battery, comprising:
a positive electrode;
a negative electrode;
a separator; and
the sulfone-based electrolyte according to claim 1.

12. The secondary battery according to claim 11, wherein the secondary battery generates a non-flammable gas when stored at a high temperature.

13. The secondary battery according to claim 11, wherein the secondary battery has an ion conductivity of 0.1 mS/cm to 10 mS/cm.
